(19) United States
(12) Patent Application Publication
(10) Pub. No.: US 2026/0231911 A1
(43) Pub. Date: Aug. 13, 2026

(54) MOBILE FISHING ASSEMBLY

(71) Applicants: Irving Russell, Ferndale, NY (US); Brian William Russell, Ferndale, NY (US)

(72) Inventors: Irving Russell, Ferndale, NY (US); Brian William Russell, Ferndale, NY (US)

(21) Appl. No.: 19/263,464

(22) Filed: Jul. 8, 2025

Related U.S. Application Data
(60) Provisional application No. 63/732,670, filed on Sep. 10, 2024.

(51) Int. Cl. A01K 63/02; A01K 63/04; B60P 3/04; B60P 3/22; B60P 3/24; B60R 3/00

(52) U.S. Cl. CPC A01K 63/02; A01K 63/042; A01K 63/045; B60P 3/225; B60P 3/226; B60P 3/2265; B60P 3/24; B60R 3/007; B60P 3/04

(57) ABSTRACT

A mobile fishing assembly provides a fishing experience to participants in various locations. The assembly includes a water tank mounted on a flat chassis with hinged dividers that form three sections for transport. The assembly integrates systems to cool, aerate, and clean the water to ensure fish survival during transport. A cover secured over the central tank section prevents water spillage and fish loss during transport and may be formed from a detachable frame with a semi-flexible material or other suitable material. Movable walkways and a removable stairway with handrails provide safe participant access. Upon arrival at an event, the dividers are lowered, allowing the fish to swim freely. The assembly includes a plumbing system that supports filtration and temperature control through circulation and aeration. Fishing poles may be mounted along ledges of the assembly for safe participant use. The water tank may be formed from steel, aluminum, fiberglass, or other suitable materials sufficient to support the water and fish weight.

### CROSS-REFERENCE TO RELATED APPLICATIONS

This application claims the benefit of U.S. Application Ser. No. 63/732,670, filed on Jul. 8, 2024.

### FIELD

The apparatuses and methods of the disclosure are generally related to mobile aquatic animal habitat and fishing structures enabling persons to easily deploy, use, stow, and transport an aquatic animal containment structure including a water tank.

### BACKGROUND

There are many and varied diversions that can be brought to children's parties and activities. Most involve rides and jumping devices. Examples include inflatable bounce houses, inflatable slides, obstacle courses, mechanical rides such as carousels or train rides, and climbing walls. These amusements are often designed to provide physical activity and high-energy excitement in a controlled environment.

Such attractions typically offer only short bursts of engagement and often lack educational or nature-based components. In urban or suburban settings, they may do little to expose children to animals, ecosystems, or outdoor skills. Additionally, they can be noisy, require significant power sources, and may pose safety concerns due to crowding or improper supervision. Many of these diversions are passive or repetitive, providing little opportunity for participants, including children, to engage in meaningful interaction or learning. As a result, there is a growing interest in alternative forms of mobile attractions that offer a more enriching, interactive, and educational experience.

### SUMMARY

This disclosure generally relates to mobile aquatic systems, and in particular to mobile fishing assemblies and mobile water containment systems that support water conditioning, compartmentalization, and safe transport of aquatic animals. The systems enable modular configurations that enhance water quality, reduce animal stress, and improve usability during both active use and transport.

According to one aspect of the disclosure, a mobile fishing assembly includes a trailer configured to be towed by a vehicle, and a water tank mounted to the trailer. The water tank includes a bottom, opposing side walls, and opposing end walls. Dividers are movably attached to the bottom of the water tank and movable between a lowered position in which the water tank is undivided and a raised position in which the dividers form compartments, including side compartments and a water-tight compartment. Each divider includes sealing members to prevent water flow outside of the water-tight compartment when in the raised position.

A fluid system includes screened pipes positioned along the opposing side walls and configured to circulate water through the compartments. The mobile fishing assembly further includes a water-retaining cover configured to prevent water spillage and fish escape, at least one platform movably coupled to a side of the trailer and movable between a stowed position and a deployed position, and a collapsible stairway removably coupled to the at least one platform.

In aspects, the mobile fishing assembly may further include a fishing pole holder removably coupled to a ledge or the at least one platform of the water tank. The water-retaining cover may be removably coupled to at least one of the compartments. A handrail may be coupled to at least one platform. In some aspects, piping may run alongside the outer walls of the fishing tank and may be coupled to a filtration system, a cooling system, and an aeration system.

The fluid system may include a valve-controlled pipe network coupled to ports in the side compartments and configured to transfer water from the side compartments to the water-tight compartment prior to transport. In aspects, the water-retaining cover may include a detachable frame and a semi-flexible material configured to retain water and prevent fish loss during transport. A reservoir may be coupled to a front portion of the water tank and configured to receive circulated water and overflow into the tank to aerate water in the water tank. The fluid system may be configured to aerate, filter, and cool the water during use and during transport. The dividers may be maintained in the raised position during transport by at least one tension rod removably coupled to the dividers.

In accordance with another aspect of the disclosure, a mobile water containment system for aquatic animals includes a water tank having a bottom, opposing side walls, and opposing end walls, and dividers movably coupled to the bottom of the water tank and movable between a lowered position in which the water tank is undivided and a raised position in which the dividers form compartments to control the distribution of water and aquatic animals. Each divider includes sealing members to prevent water flow outside of a portion of the compartments when in the raised position. A fluid system includes pipes and ports configured to circulate water among the compartments.

In aspects, the fluid system may include valves configured to direct water between compartments formed by the dividers. The system may further include a removable cover configured to enclose at least one compartment during transport. The cover may include a frame and a semi-flexible polymeric sheet coupled to the frame. The fluid system may be configured to operate during transport to maintain circulation, filtration, cooling, and aeration of the water in the water tank. A reservoir may be in fluid communication with the water tank to allow water to overflow into the water tank to provide aeration.

Piping may be coupled to the exterior of the water tank and configured to couple to a filtration system, a cooling system, and an aeration system. The tank may be constructed of a material selected from the group consisting of steel, aluminum, a metal alloy, fiberglass, and any combination thereof. Each pipe may include an inlet port or an outlet port with a filter to prevent the aquatic animals from entering the fluid system. The ports may include an outlet port positioned within each compartment to supply circulated water to each compartment.

The details of one or more aspects of the disclosure are set forth in the accompanying drawings and the description below. Other features, objects, and advantages of the apparatuses and methods described in this disclosure will be apparent from the description and drawings, and from the claims.

### BRIEF DESCRIPTION OF DRAWINGS

FIG. 1 is a perspective view of the interior of a tank used in a mobile fishing assembly that illustrates an example configuration of hinged dividers according to aspects of the disclosure.

FIG. 2 is a side view of a mobile fishing assembly in its closed and transportable state according to aspects of the disclosure.

FIG. 3 is a perspective view of a mobile fishing assembly in its open and operational state according to aspects of the disclosure.

FIG. 4 is a perspective view of the front portion of a mobile fishing assembly that illustrates a cooling system, a cooling system mount, and a filtration system, according to aspects of the disclosure.

FIG. 5 is a perspective view of a mobile fishing assembly showing the jacks, UV water sanitizing system, inlet and outlet plumbing, equipment platform, and hitch attachment, according to aspects of the disclosure.

FIG. 6 is a perspective view of a plumbing junction including valves configured to selectively divert water to individual sections of the tank according to aspects of the disclosure.

FIG. 7 is a perspective view of two pipes plumbed along a side of the tank of a mobile fishing assembly according to aspects of the disclosure.

FIG. 8 is a perspective view of two pipes plumbed along an opposite side of the tank of the mobile fishing assembly according to aspects of the disclosure.

FIG. 9 is a perspective view of a reservoir mounted to the front of the mobile fishing assembly according to aspects of the disclosure.

FIG. 10 is a perspective view showing piping connections mounted to an exterior side of the tank of the mobile fishing assembly according to aspects of the disclosure.

FIG. 11 is a perspective view showing additional piping connections on an opposite exterior side of the tank of the mobile fishing assembly according to aspects of the disclosure.

FIG. 12 is a perspective view of an interior fitting mounted to the inside of an outlet pipe within the mobile fishing assembly according to aspects of the disclosure.

FIG. 13 is a perspective view of the interior of the tank showing dividing walls in an upright position and an inlet pipe positioned to deliver water into the section according to aspects of the disclosure.

FIG. 14 is a perspective view of the interior of the tank with water in the center compartment and dividing walls held upright using tension rods according to aspects of the disclosure.

FIG. 15 is a top view of removable lids positioned over the center compartment of the tank, with clamps securing the lids in place according to aspects of the disclosure.

FIG. 16 is a perspective view of walkways in an upright position alongside the tank according to aspects of the disclosure.

FIG. 17 is a side view of the mobile fishing assembly in a transport configuration, showing the underside of the walkways, wheels on double axles, and a supporting chassis according to aspects of the disclosure.

FIG. 18 is a perspective view of the interior of the tank with the dividing walls in a lowered position and water dispersed throughout the tank according to aspects of the disclosure.

FIG. 19 is a perspective view of the fishing and fish viewing area in an operational configuration, showing pole holders and fishing poles positioned along the ledge of the tank according to aspects of the disclosure.

FIG. 20 is a perspective view of the mobile fishing assembly in a full display configuration, showing signage, an optional tent, and structural features along the walkways according to aspects of the disclosure.

### DETAILED DESCRIPTION

A growing interest surrounds a newly developed installation that delivers the experience of fishing in a mobile, event-ready format. This consists of a large tank containing water mounted on a flat chassis that can be hitched to a vehicle and moved from one location to another. The tank can be supplied with live fish. There may be integrated systems that simultaneously cool, aerate, and clean the water. These systems ensure the survival of the fish as they are transported, in some cases long distances, to and from events. There may be retractable walkways and a removable stairway, both with handrails to ensure safety. Participants enjoy both the act of attempting to catch the fish and the experience of being able to look down into the open tank and observe them up close. In many communities, especially those that may be more urban, the opportunity to interact with nature can be limited. The system provides an interactive experience that, for many participants, may represent their first opportunity to attempt fishing.

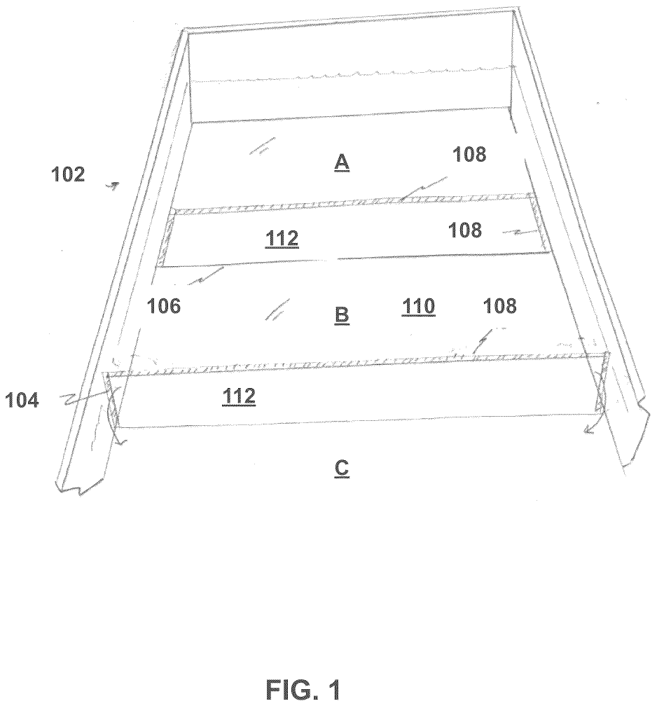

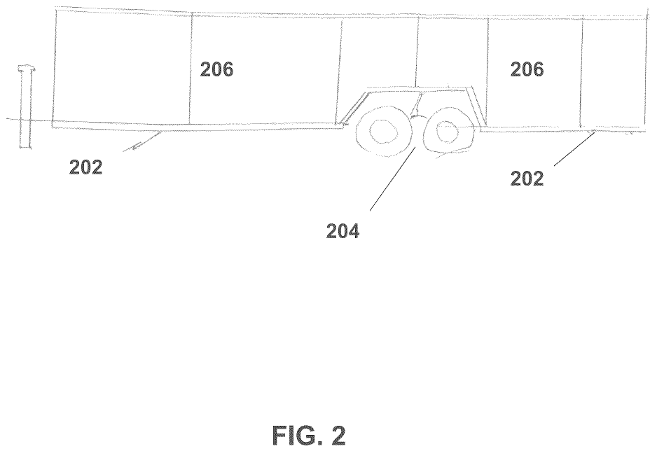

As shown in FIGS. 1 and 2, the mobile fishing assembly includes a rectangular tank. The tank may be permanently mounted on the chassis 204, which provides a platform that may be slightly larger in perimeter than the tank. The tank 102 may be divided into three sections by means of two dividers 112. The dividers may be hingedly 106 affixed to the bottom 110 of the tank in such a manner that they can be lowered to lie flat against the bottom of the tank or raised to be vertical 104 and thereby divide the tank into the three sections (labeled A, B, and C in FIG. 1). The edges of the dividers may be fitted with sealing means or gaskets 108 so that when raised they can prevent water from passing through the sides from one section to another.

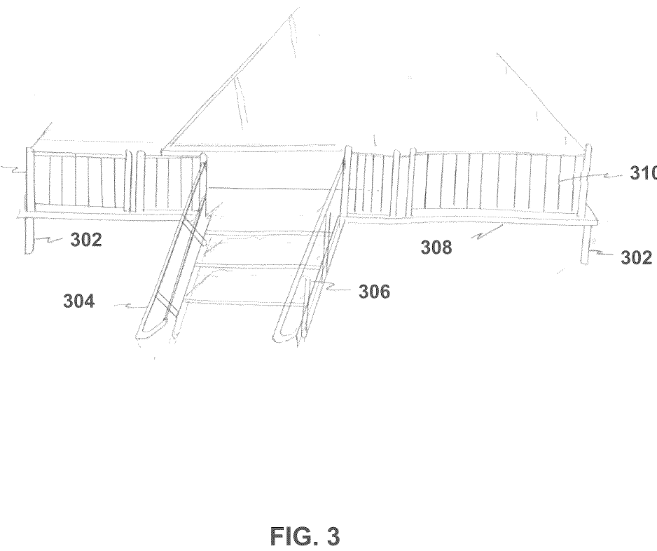

As shown in FIGS. 2 and 3, the mobile fishing assembly includes walkways 206, 308 that may be attached by hinges 202 to each side of the assembly. The walkways can be raised to a vertical position 206 to allow for transport or lowered to a horizontal position 308 when the system is set up for use. The walkways can be supported by detachable or collapsible legs 302. A removable walkway 306 with hand rails 304 may be attached to the entry area of the system that allows participants to safely enter and exit. The walkways have safety rails 310 that also ensure the safety of participants.

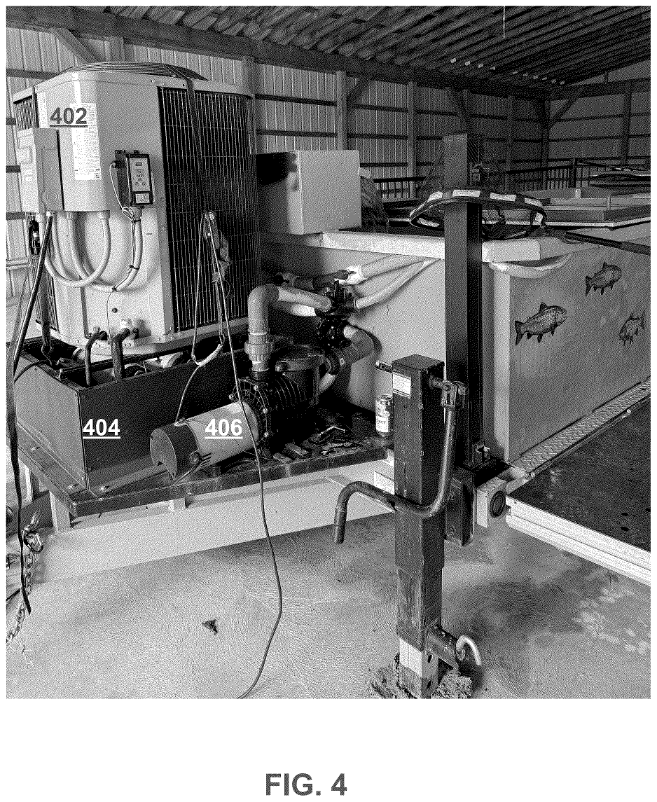

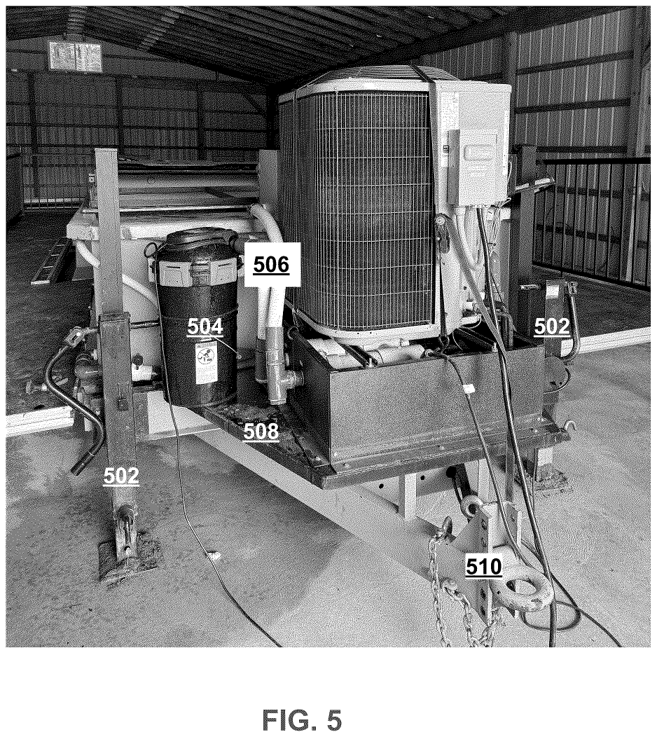

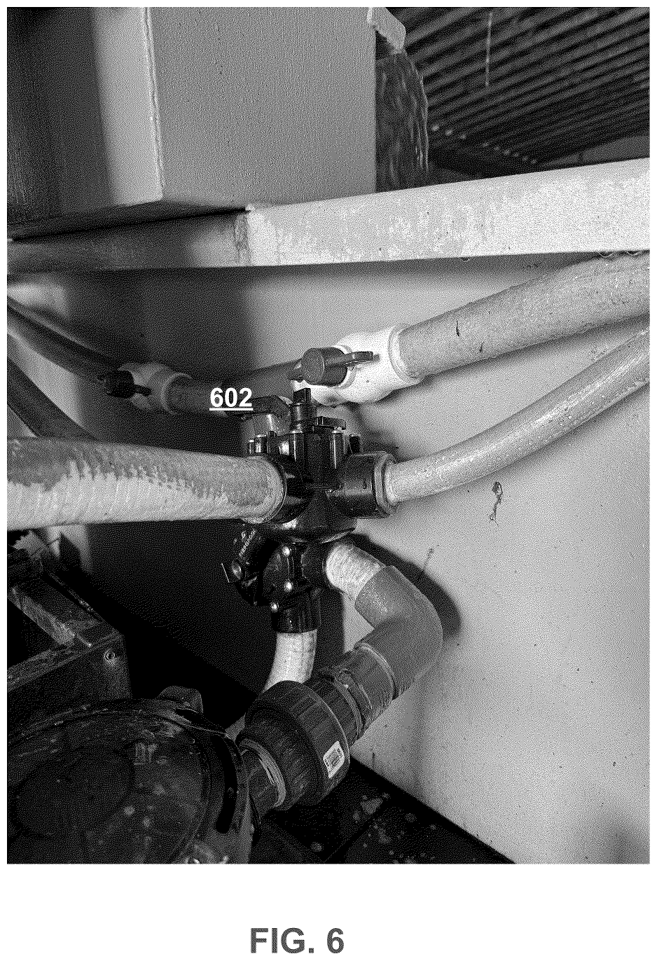

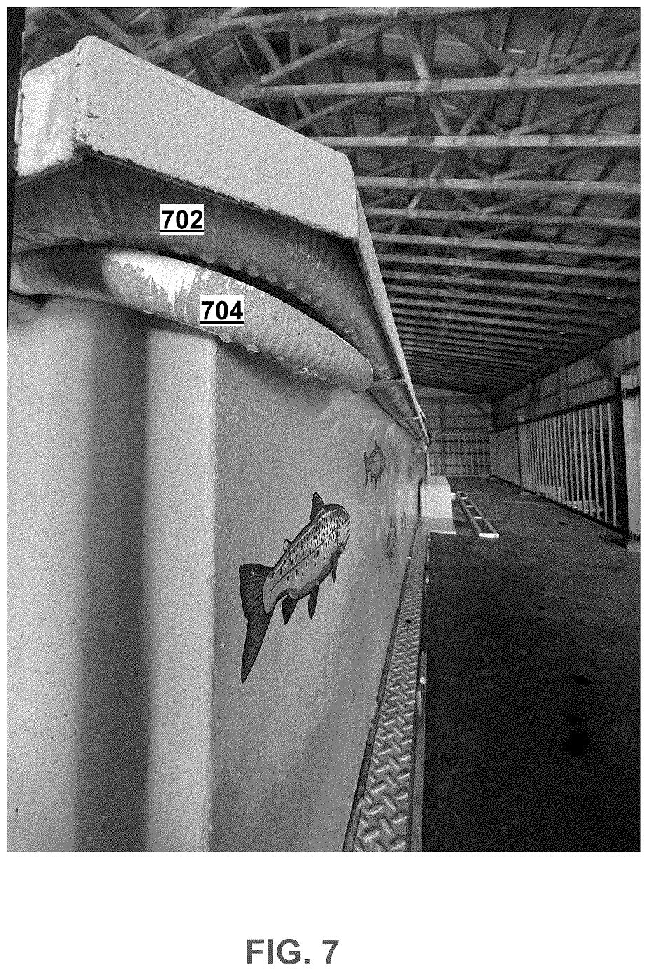

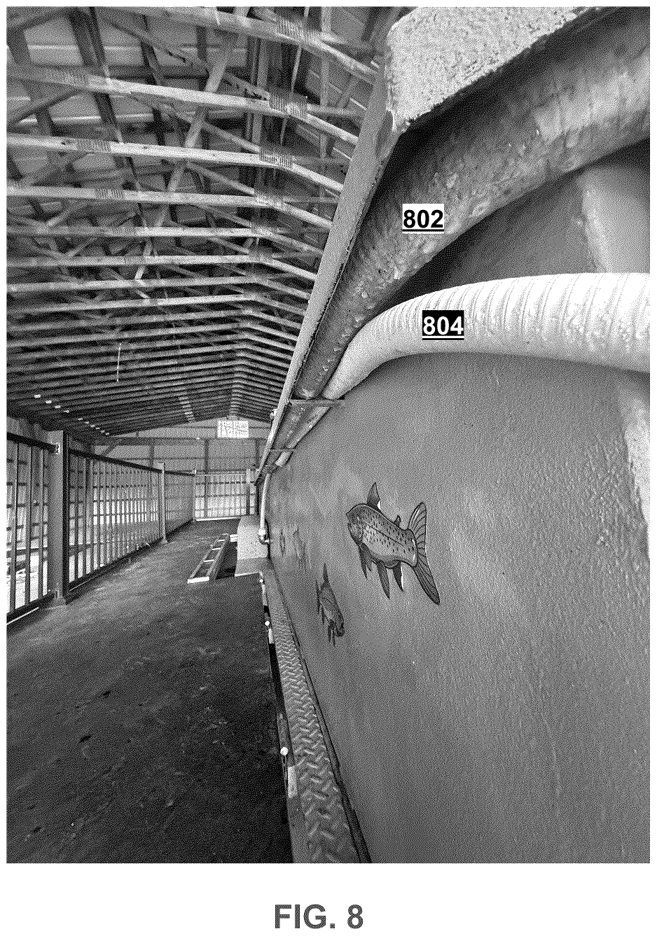

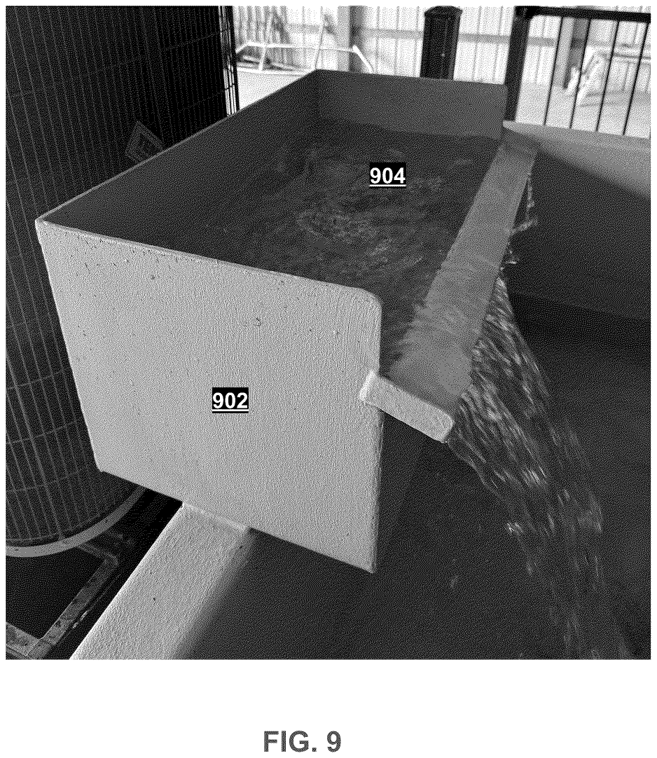

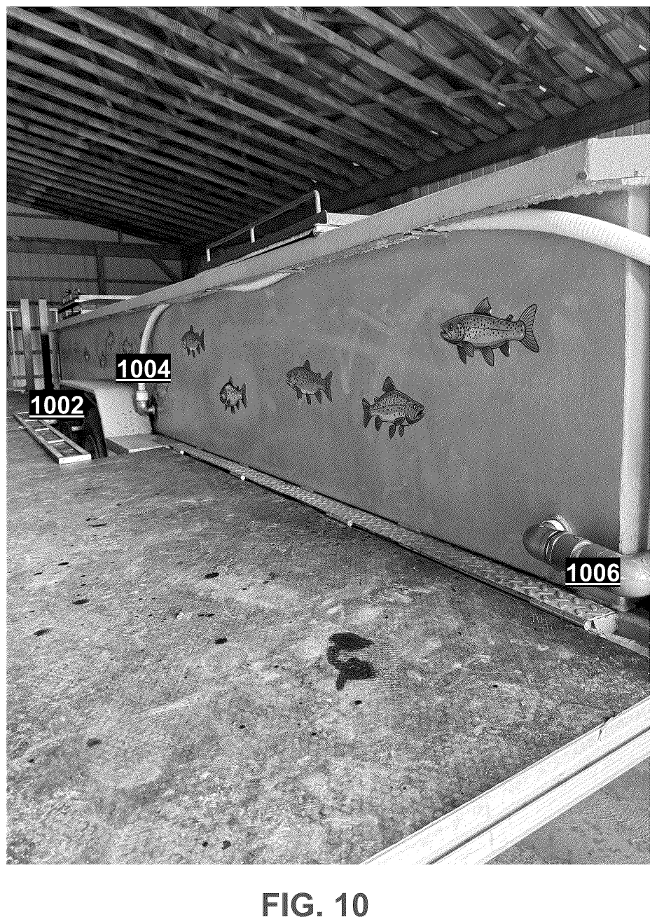

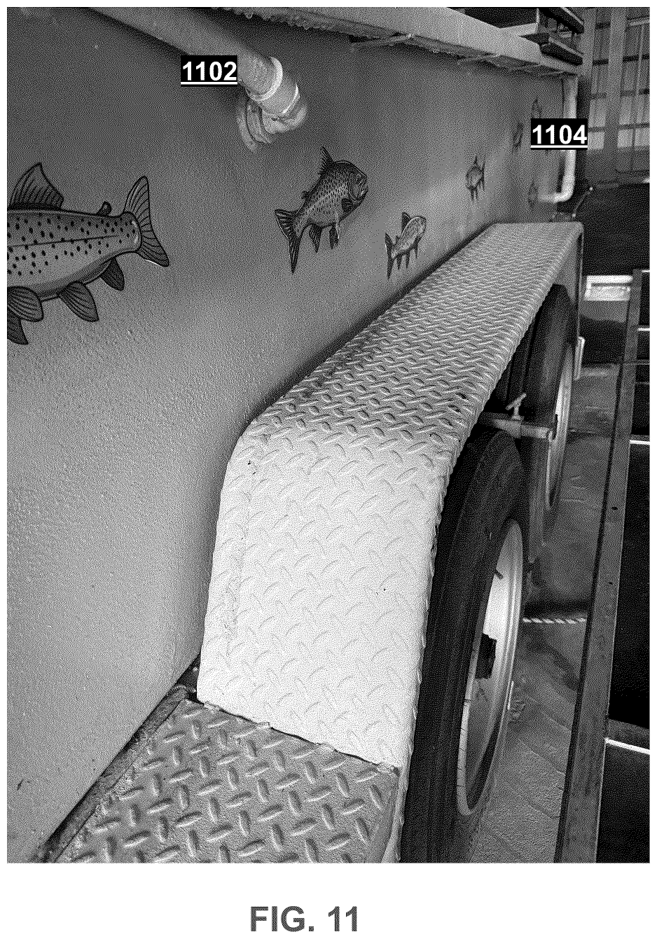

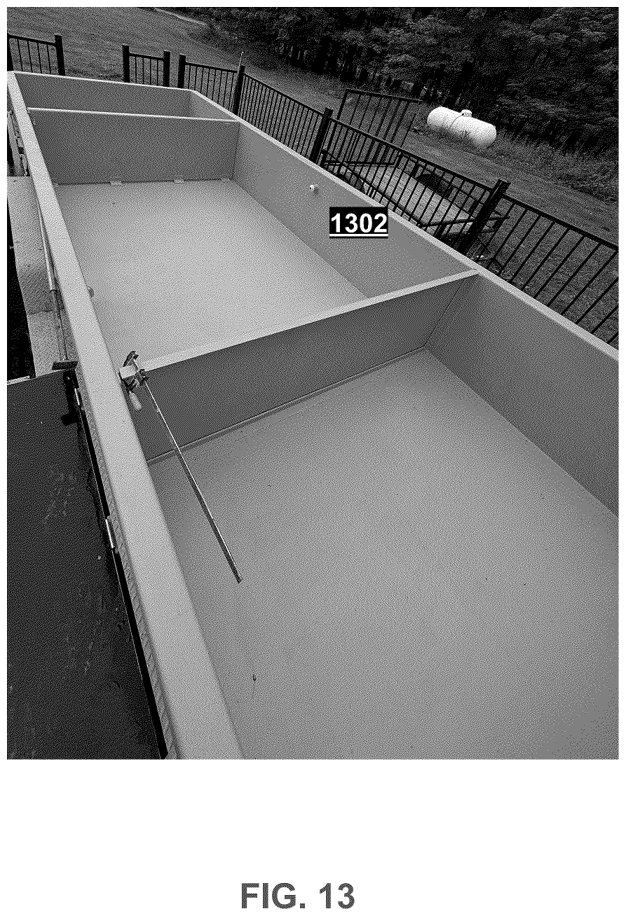

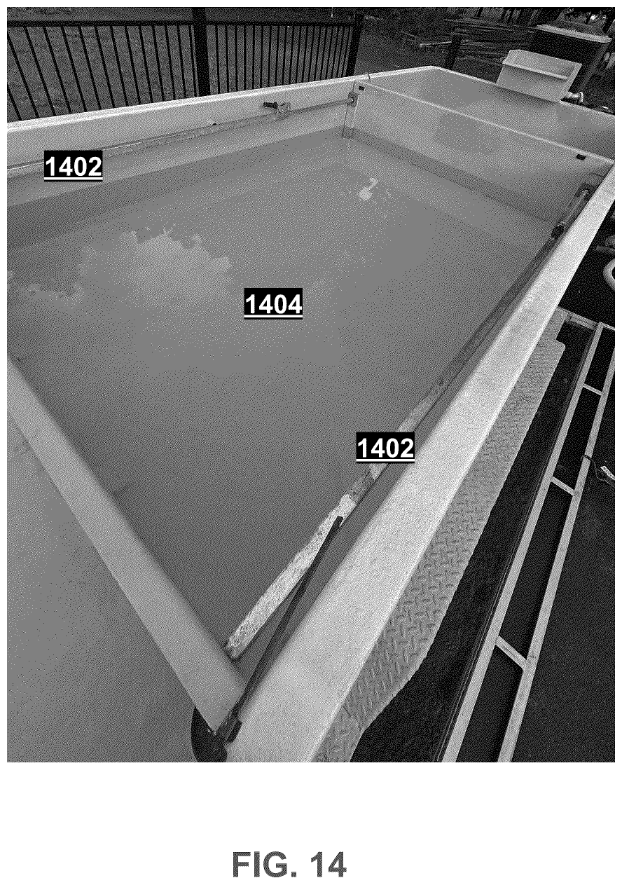

As shown in FIGS. 4 and 5, a base 508 supports a water purifying system 504, a filtration system 406, and a mount 404 that supports a cooling system 402. Jacks 502 may be positioned on both sides of the trailer to stabilize the assembly during stationary operation. A hitch 510 allows for connection to a towing vehicle. Piping 506 allows for the flow of water through these systems. A plumbing junction with valves 602 allows for water to be diverted to individual compartments of the tank based on operational needs. This is further described below in FIGS. 6-14.

As shown in FIGS. 6-14, a reservoir 902 may be attached to the front of the tank. Water flows through an inlet spout 904 located in the bottom corner of the reservoir. The reservoir overflows back into the tank. It may be operational only when the dividers may be open and water may be distributed across all three sections of the tank. This serves as the primary inlet for water while the fishing operation is stationary. Water lines 702, 704, 802, 804 may be routed underneath the ledge of the steel tank. Outlet piping 1002, 1004, 1006, 1104 draws water from the tank to be circulated through the previously described systems and returned to the reservoir, where it is redeposited into the tank.

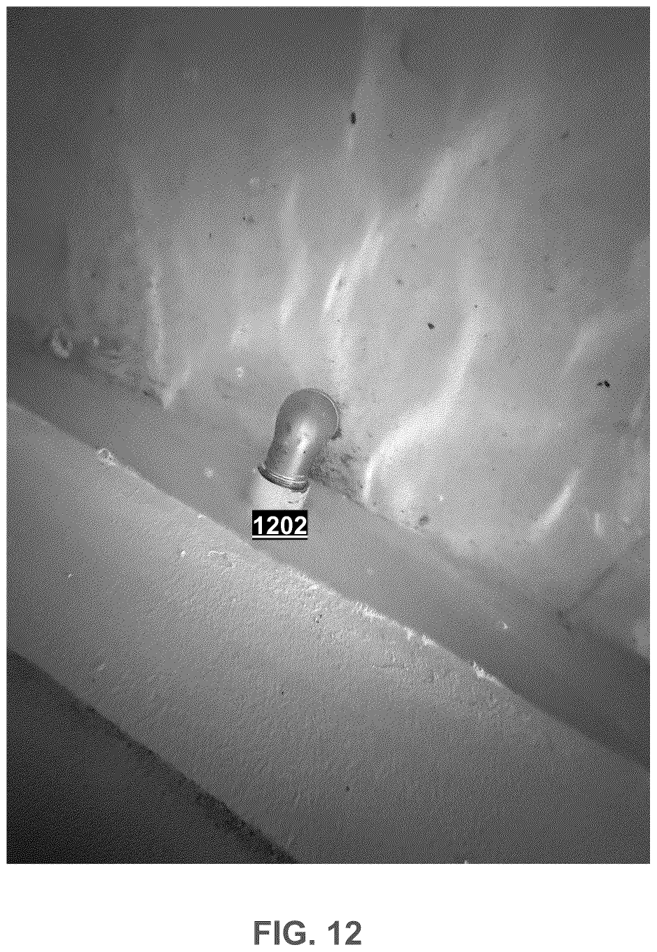

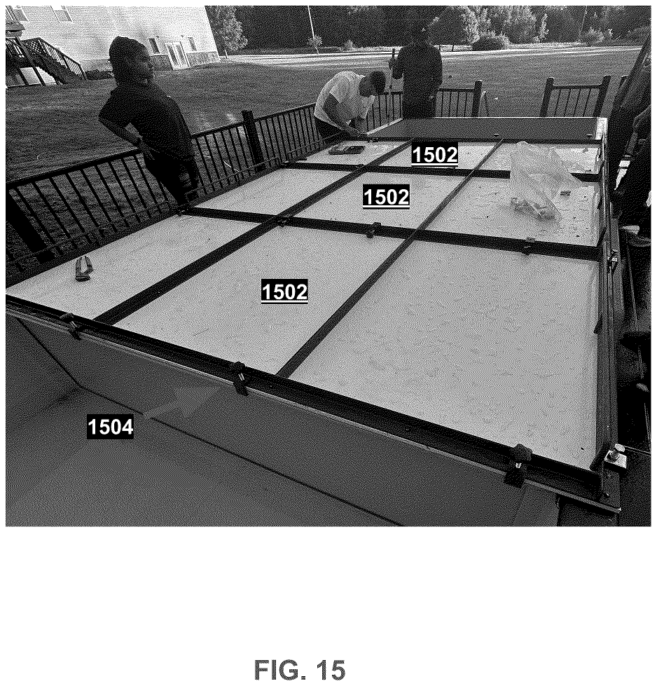

A plumbing junction with valves 602 allows water to be diverted into the center compartment of the tank. This enables outlet piping in the front and rear compartments to redirect water through the inlet pipe 1102 into the middle section. In FIG. 12, component 1202 shows an outlet pipe with a downward facing, screened fitting to prevent fish from entering the system. An inlet spout 1302 directs water into the center compartment and helps maintain a sealed water environment 1402. As shown in FIG. 15, steel framed lids 1502 supporting a flexible but durable material may be secured with clamps 1504. This encloses the water and fish and prevents sloshing, overspill, and loss of fish during transport.

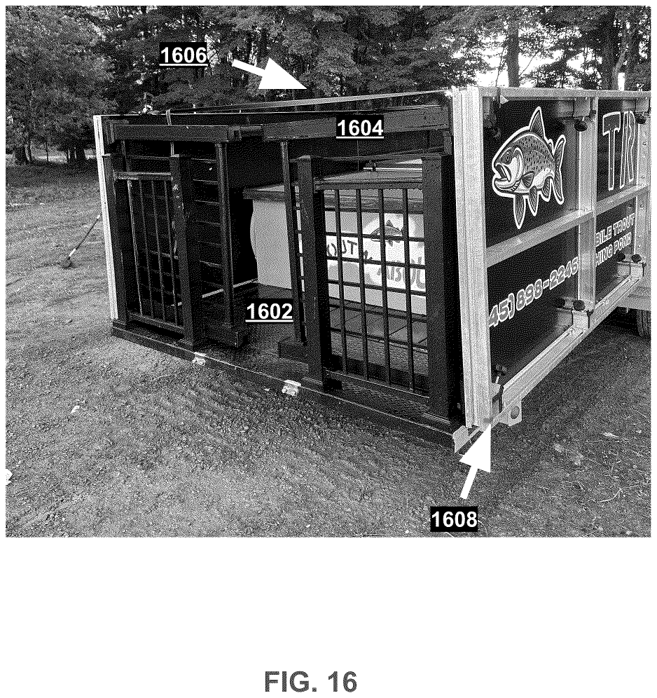

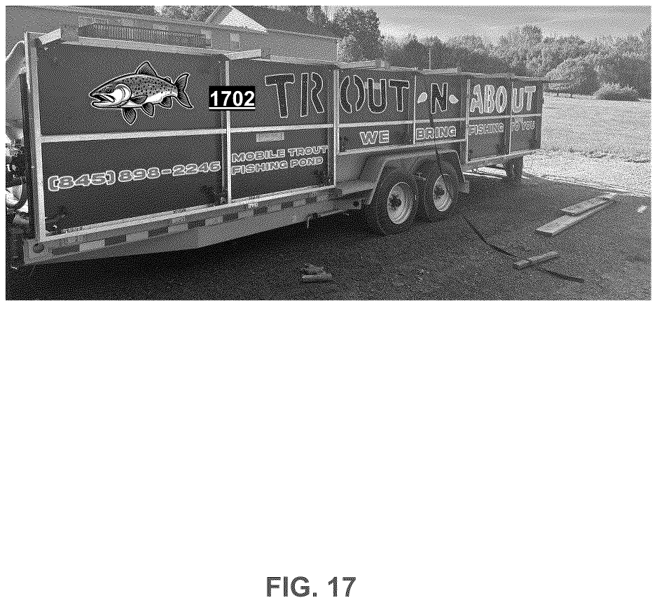

As shown in FIGS. 16 and 17, the fishing assembly is depicted in its closed and transportable state. The stairway has been removed from the entry platform 1602 and stored. The railings 1604 may be configured to fit compactly above the assembly. The walkway foot holes 1608 may be flush with the trailer surface to avoid protrusion. A fastening device 1606 secures the walkways in their upright position during transit. 1702 shows the walkway in its upright position displaying optional logos, advertisements, and contact information.

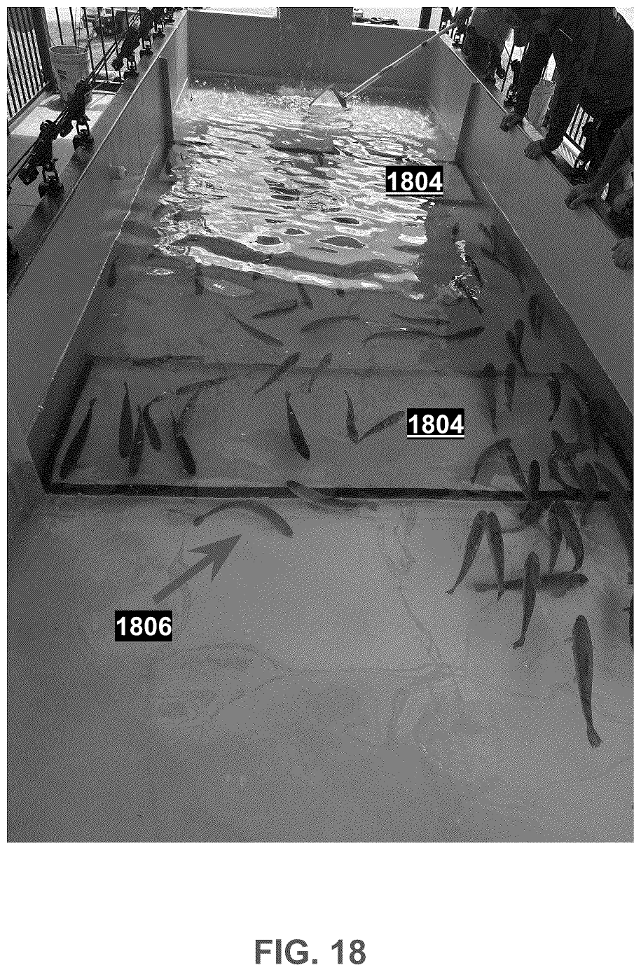

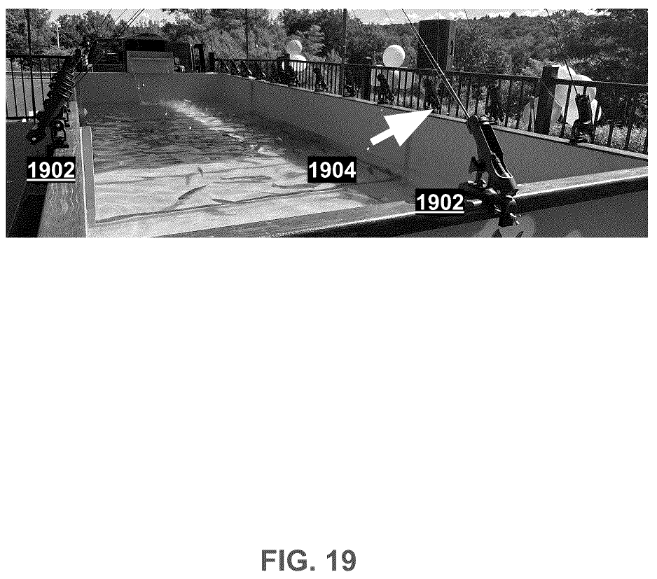

As shown in FIGS. 18 and 19, the fishing area 1804 is open and operational. The dividers may be lowered, allowing water to flow throughout the entire tank, and fish 1806 can swim freely between sections. Fishing pole holders 1902 may be positioned along the ledge to support fishing poles 1904.

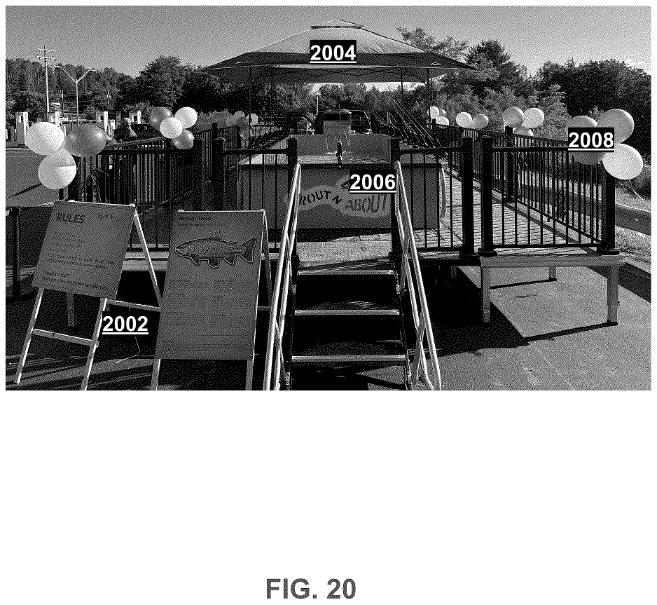

As shown in FIG. 20, a rules list and informational plaques 2002 may be placed alongside the assembly. A canopy tent may be placed over to limit the exposure to the sun. Logos or stickers may be applied to the side of the tank and balloons or other promotional items may be affixed to the walkways.

When a large tank of water is transported on a flat chassis there may be a great deal of sloshing of the water and spillage, as well as the possibility of losing the fish. When ready for transport the dividers may be raised and fixed in the vertical position. A pipe system running along the sides of the tank enables the water to be pumped from the two side sections and released into the center section. The openings of the pipe system may be screened so that no fish can enter the pipes. As the water level in the side sections is decreased, any fish that may still be in the side sections may be netted by attendants and placed into the center. When all of the water is in the center section, a cover is placed over it so no water can spill and no fish lost during transport. The cover may consist of a detachable metal frame covered with a semi flexible polymeric material to contain the water. The plumbing that enables the filtration/aeration and cooling system may be designed in a way that allows these systems to work simultaneously as the assembly is transported. This ensures the survival of the fish. These systems may be powered by a converter plugged into the towing vehicle.

When the assembly has reached its destination, the cover is removed and the dividers may be slowly lowered allowing the water with the fish to spread out into the full tank. The depth of the water along the full-length of the tank may be slightly less than half the depth of the tank. The fish can now swim freely throughout the tank and may be easily seen. The plumbing, which may include pipes, runs alongside the exterior walls of the tank to maintain the integrity of the water with aerators as needed. Careful temperature control and a cooling system to maintain the fish in proper conditions and at the proper cool temperature.

The participants, e.g., children, may be given the fishing poles with the special hooks and may fish from the platform. When a fish is caught an attendant removes the fish and returns it to the tank. The laws may be specific such that the children are not allowed to actually touch the fish so attendants may be present to remove them from the hook with as little injury to the fish as possible.

Plaques with information about the type of fish or fishes that may be in the tank may be set up next to the trailer. This entire assembly is geared to introduce participants, e.g., children, to the sport of fishing and to educate them about the type of fish that they can catch at this site. The fish may be obtained from a licensed fish hatchery.

The mobile fishing assembly may include a fishing pole holder coupled to a ledge of the water tank. The fishing pole holder may be removable. As staff prepare the experience, they place jig poles, poles without reels, into the pole holders. The fishing line that may be attached to these poles may be measured to a specific length. This simplifies the process and allows for the participant to only have to lift the fish out of the water. The experience has enough staff stationed along the platforms to ensure proper supervision and prompt reaction. In the event that a participant catches a fish, the trained staff will use a net to scoop the fish up, remove the hook from the fish's mouth, and seamlessly place it back into the tank. Special hooks may be chosen in a way that limits impact to the fish. These hooks may be dull, barbless, and a specific size that prevents the fish from swallowing the hook.

The water tank of the mobile fishing assembly may be made of a material strong enough to support the weight of the amount of water needed to sustain the fish and the weight of the fish. In one configuration, the water tank may be made of steel. Other materials that may be sufficient include steel, aluminum, a suitable metal alloy, fiberglass, or any combination thereof.

The mobile fishing assembly may include a handrail coupled to at least one platform. In one example configuration, the tank may be raised approximately three feet off the ground. A platform is needed in order to create a vantage point for the participants to be able to view the fish and participate in the activity. A handrail that meets safety standards surrounds the platform and ensures the safety of participants. A removable stairway with removable handrails may be installed at the entrance of the platform to allow participants to safely enter and exit the activity.

The mobile fishing assembly of claim 1, includes piping that runs alongside the outer walls of the fishing tank and connects to a filtration system, cooling system, and also serves to help aerate the water. The cooling system keeps the water temperature at an optimal level for the health of the fish. The filtration system assists in keeping the water clean. While the assembly is in its open position, this water is further circulated back into the tank through a reservoir that may be positioned at the front of the tank. This reservoir overflows back into the tank and helps to aerate the water and prevent stagnation. It may be plumbed in a way that, in its closed and mobile position, the water is circulated through the piping into the portion of the tank that contains the fish. This ensures the survival of the fish during transport as it prevents the temperature of the water rising to dangerous levels and allows for the flow of oxygen to the fish.

In one prototype, the water tank may be a steel tank mounted on a utility trailer. In aspects, the design could be built on any platform mounted on a chassis that may be towable by a vehicle large enough to support the weight of the water, fish, and all needed equipment.

It should be understood that various aspects disclosed herein may be combined in different combinations than the combinations specifically presented in the description and accompanying drawings.

What is claimed is:

1. A mobile fishing assembly comprising:
a trailer configured to be towed by a vehicle;
a water tank mounted to the trailer, the water tank including a bottom, opposing side walls, and opposing end walls;
dividers movably attached to the bottom of the water tank and movable between a lowered position where the water tank is undivided and a raised position wherein the dividers form compartments including side compartments and a water-tight compartment, each divider including sealing members to prevent water flow outside of the water-tight compartment when in the raised position;
a fluid system including screened pipes positioned along the opposing side walls and configured to circulate water through the compartments;
a water-retaining cover configured to prevent water spillage and fish escape;
at least one platform movably coupled to a side of the trailer and movable between a stowed position and a deployed position; and
a collapsible stairway removably coupled to the at least one platform.

2. The mobile fishing assembly of claim 1, further comprising a fishing pole holder removably coupled to a ledge or the at least on platform of the water tank.

3. The mobile fishing assembly of claim 1, wherein the water-retaining cover is removably coupled to at least one of the compartments.

4. The mobile fishing assembly of claim 1, further comprising a handrail coupled to the at least one platform.

5. The mobile fishing assembly of claim 1, further comprising piping that runs alongside the outer walls of the fishing tank and is coupled to a filtration system, a cooling system, and an aeration system.

6. The mobile fishing assembly of claim 1, wherein the fluid system includes a valve-controlled pipe network coupled to ports in the side compartments and configured to transfer water from the side compartments to the water-tight compartment prior to transport.

7. The mobile fishing assembly of claim 1, wherein the water-retaining cover includes a detachable frame and a semi-flexible material configured to retain water and prevent fish loss during transport.

8. The mobile fishing assembly of claim 1, further comprising a reservoir coupled to a front portion of the water tank, wherein the reservoir is configured to receive circulated water and overflow into the tank to aerate water in the water tank.

9. The mobile fishing assembly of claim 1, wherein the fluid system is configured to aerate, filter, and cool the water during use and during transport.

10. The mobile fishing assembly of claim 1, wherein the dividers are maintained in the raised position during transport by at least one tension rod removably coupled to the dividers.

11. A mobile water containment system for aquatic animals, comprising:
a water tank having a bottom, opposing side walls, and opposing end walls;
dividers movably coupled to the bottom of the water tank and movable between a lowered position wherein the water tank is undivided and a raised position wherein the dividers form compartments to control the distribution of water and aquatic animals, each divider including sealing members to prevent water flow outside of a portion of the compartments when in the raised position; and
a fluid system including pipes and ports configured to circulate water among the compartments.

12. The mobile water containment system of claim 11, wherein the fluid system includes valves configured to direct water between compartments formed by the dividers.

13. The mobile water containment system of claim 11, further comprising a removable cover configured to enclose at least one compartment during transport.

14. The mobile water containment system of claim 13, wherein the cover includes a frame and a semi-flexible polymeric sheet coupled to the frame.

15. The mobile water containment system of claim 11, wherein the fluid system is configured to operate during transport to maintain circulation, filtration, cooling, and aeration of the water in the water tank.

16. The mobile water containment system of claim 11, further comprising a reservoir in fluid communication with the water tank to allow water to overflow into the water tank to provide aeration.

17. The mobile water containment system of claim 11, further comprising piping coupled to the exterior of the water tank and configured to couple to a filtration system, a cooling system, and an aeration system.

18. The mobile water containment system of claim 11, wherein the tank is constructed of a material selected from the group consisting of steel, aluminum, a metal alloy, fiberglass, and any combination thereof.

19. The mobile water containment system of claim 11, wherein each pipe includes an inlet port or an outlet port with a filter to prevent the aquatic animals from entering the fluid system.

20. The mobile water containment system of claim 11, wherein the ports include an outlet port positioned within each compartment to supply circulated water to each compartment.
